(19) United States
(12) Patent Application Publication
(10) Pub. No.: US 2004/0192549 A1
(43) Pub. Date: Sep. 30, 2004

(54) Image-formed object, method for image formation, and thermal transfer sheet for preparation of said image-formed object

(76) Inventors: Kozo Odamura, Tokyo-to (JP); Takayuki Imai, Tokyo-to (JP)

Correspondence Address: HARNESS, DICKEY & PIERCE, P.L.C., P.O. BOX 828, BLOOMFIELD HILLS, MI, 48303, US

(21) Appl. No.: 10/812,811

(22) Filed: Mar. 30, 2004

(30) Foreign Application Priority Data
Mar. 31, 2003 (JP) 2003-96247

(51) Int. Cl. B41M 5/20

(52) U.S. Cl. 503/201; 428/195.1

(57) ABSTRACT

There are provided an image-formed object, a method for image formation, and a thermal transfer sheet for the preparation of an image-formed object, which can prevent a photoreaction between a photocolor emitting material and a colorant to prevent image color fading and the formation of an unsharp image. The image-formed object comprises: an image-receiving sheet; an image, viewable upon exposure to visible light, provided on the image-receiving sheet; and an image, capable of emitting fluorescence upon exposure to ultraviolet light, provided on the image viewable upon exposure to the visible light through a protective layer. The method for image formation comprises the step of forming an image viewable upon exposure to visible light, a protective layer, and an image capable of emitting fluorescence upon exposure to ultraviolet light in a serial manner on an image-receiving sheet. The thermal transfer sheet for use in the preparation of the image-formed object comprises: a substrate sheet; and, provided on the substrate sheet, a colorant transfer layer for forming an image viewable upon exposure to visible light, a protective layer transfer layer for forming a protective layer, and a fluorescent color emitting agent transfer layer for forming an image capable of emitting fluorescence upon exposure to ultraviolet light.

### BACKGROUND OF THE INVENTION

1. Field of the Invention

The present invention relates to an image-formed object, a method for image formation, and a thermal transfer sheet for the preparation of the image-formed object.

2. Background Art

The formation of an image, which emits light upon exposure to ultraviolet light, on articles such as credit cards, bank cards, and ID cards has hitherto been made, for example, from the viewpoint of preventing forgery or alteration of the articles such as the cards.

The images capable of emitting light upon exposure to ultraviolet light in the articles such as the cards are generally preprinted as a latent image on a card substrate.

When the images capable of emitting light upon exposure to ultraviolet light is preprinted, however, it disadvantageously becomes difficult to form any desired images, characters or the like (usually viewable upon exposure to visible light) on the preprinted images.

Further, when images, characters or the like viewable upon exposure to visible light are formed directly on images capable of emitting light upon exposure to ultraviolet light, a photoreaction takes place between the fluorescent color emitting material and the colorant, and, consequently, image color fading and/or the formation of an unsharp image sometimes occur.

### SUMMARY OF THE INVENTION

Accordingly, an object of the present invention is to solve the above problems of the prior art.

According to one aspect of the present invention, there is provided an image-formed object comprising: an image-receiving sheet; an image, viewable upon exposure to visible light, provided on the image-receiving sheet; and an image, capable of emitting fluorescence upon exposure to ultraviolet light, provided on the image viewable upon exposure to the visible light through a protective layer.

In this image-formed object according to the present invention, the image capable of emitting fluorescence upon exposure to ultraviolet light may be substantially non-viewable upon exposure to visible light.

In the image-formed object, the image capable of emitting fluorescence upon exposure to ultraviolet light may be formed by thermal transfer.

In the image-formed object, the image viewable upon exposure to visible light may be formed by thermal transfer.

According to another aspect of the present invention, there is provided a method for image formation, comprising the step of forming an image viewable upon exposure to visible light, a protective layer, and an image capable of emitting fluorescence upon exposure to ultraviolet light in a serial manner on an image-receiving sheet.

Further, according to still another aspect of the present invention, there is provided a thermal transfer sheet for use in the preparation of the image-formed object, said thermal transfer sheet comprising: a substrate sheet; and, provided on the substrate sheet, a colorant transfer layer for forming an image viewable upon exposure to visible light, a protective layer transfer layer for forming a protective layer, and a fluorescent color emitting agent transfer layer for forming an image capable of emitting fluorescence upon exposure to ultraviolet light.

Furthermore, according to a further aspect of the present invention, there is provided a thermal transfer sheet for use in the preparation of the image-formed object, said thermal transfer sheet comprising: a substrate sheet; and, provided on the substrate sheet in a face serial manner, a colorant transfer layer for forming an image viewable upon exposure to visible light, a protective layer transfer layer for forming a protective layer, and a fluorescent color emitting agent transfer layer for forming an image capable of emitting fluorescence upon exposure to ultraviolet light.

### BRIEF DESCRIPTION OF THE DRAWINGS

FIG. 1 is a typical cross-sectional view of one embodiment of the image-formed object according to the present invention;

FIG. 2 is a typical cross-sectional view of one embodiment of the thermal transfer sheet for the preparation of an image-formed object according to the present invention;

FIG. 3 is a typical cross-sectional view of a comparative image-formed object; and

FIG. 4 is a typical cross-sectional view of a comparative thermal transfer sheet for the preparation of an image-formed object.

### DESCRIPTION OF REFERENCE CHARACTERS IN THE DRAWINGS

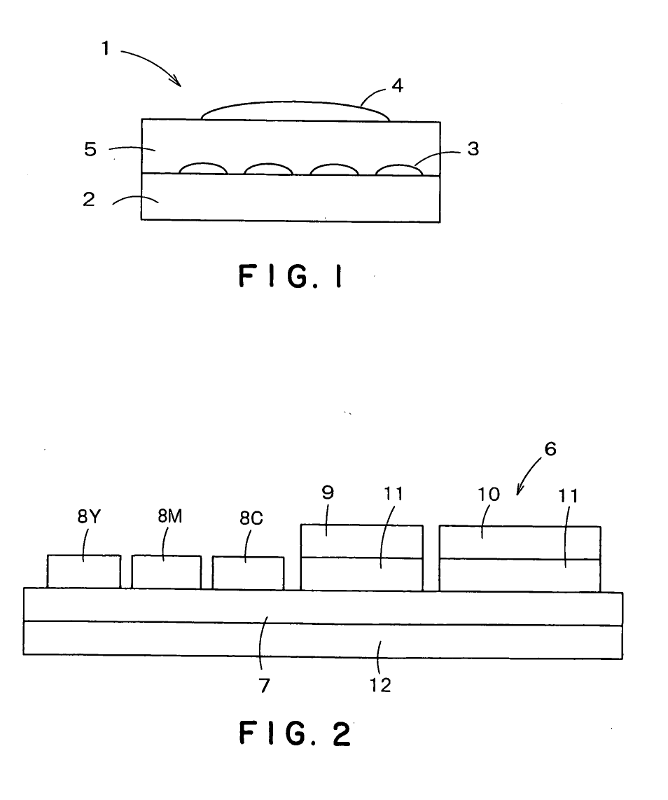

In FIGS. 1 to 4, 1: image-formed object, 2: image-receiving sheet, 3: image viewable upon exposure to visible light, 4: image capable of emitting fluorescence upon exposure to ultraviolet light, 5: protective layer, 6: thermal transfer sheet for preparation of image-formed object, 7: substrate sheet, 8: colorant transfer layer for formation of image viewable upon exposure to visible light, 9: protective layer transfer layer for protective layer formation, 10: fluorescent color emitting agent transfer layer for formation of image capable of emitting fluorescence upon exposure to ultraviolet light, 11: release layer, and 12: backside layer.

### DETAILED DESCRIPTION OF THE INVENTION

The present invention will be described, if necessary with reference to the accompanying drawings.

<Image-formed Object>

FIG. 1 is a typical cross-sectional view of a preferred embodiment of the image-formed object according to the present invention.

In an image-formed object 1 according to the present invention shown in FIG. 1, an image 3 viewable upon exposure to visible light is provided on an image-receiving sheet 2. An image 4 capable of emitting fluorescence upon exposure to ultraviolet light is provided, through a protective layer 5, on the image 3 viewable upon exposure to visible light. The interposition of the protective layer 5 between the image 3 viewable upon exposure to visible light and the image 4 capable of emitting fluorescence upon exposure to ultraviolet light can prevent a reaction between the colorant used for the formation of the image 3 viewable upon exposure to visible light and the fluorescent color emitting agent used for the formation of the image 4 capable of emitting fluorescence upon exposure to ultraviolet light. Consequently, image color fading and the formation of an unsharp image can be effectively prevented.

The image 4 capable of emitting fluorescence upon exposure to ultraviolet light may be substantially non-viewable upon exposure to visible light. The protective layer 5 is preferably formed of a visible light-transparent material, particularly substantially transparent material. According to this construction in which the image 4 capable of emitting fluorescence upon exposure to ultraviolet light is rendered substantially non-viewable upon exposure to visible light while the protective layer 5 is formed of a visible light-transparent material, under visible light, the image 3 viewable upon exposure to visible light can be viewed despite the presence of the image 4 capable of emitting fluorescence upon exposure to ultraviolet light, while, under ultraviolet irradiation, the image 4 capable of emitting fluorescence upon exposure to ultraviolet light can be viewed. Under an environment in which visible light and ultraviolet light are present together, both the image 3 viewable upon exposure to visible light and the image 4 capable of emitting fluorescence upon exposure to ultraviolet light can be viewed.

Preferably, the image 4 capable of emitting fluorescence upon exposure to ultraviolet light, the image 3 viewable upon exposure to visible light, and the protective layer 5 each are formed by thermal transfer.

An image-receiving sheet employed in the prior art with this type of thermal transfer sheet may be used, as the image-receiving sheet 2 according to the present invention, either as such or after desired modification. In the present invention, the substrate sheet is preferably formed of a resin material or a paper. Examples of resin materials and papers usable herein include (i) polyesters (preferably polyethylene terephthalate and polyethylene naphthalate), polycarbonates, polyamides, polyimides, cellulose acetate, polyvinylidene chloride, polyvinyl chloride, polystyrene, fluororesins, polyethylene, polypropylene, cellophanes, and ionomers, and (ii) papers such as glassine paper, capacitor paper, and paraffin paper. They may also be used in a combination of two or more.

The thickness of the image-receiving sheet may be properly determined by taking into consideration, for example, required strength and applications, depending upon the material used. In the present invention, for example, the thickness of the image-receiving sheet is preferably 100 to 300 μm.

The image 3 viewable upon exposure to visible light may be formed of a conventional thermally sublimable colorant or a heat-fusion colorant. Methods for thermally transferring these colorants onto the image-receiving sheet to form the image 3 are known per se. In the present invention, at least one color is properly selected from the conventional colorants and is used for the formation of the image 3 by a method which has been properly selected from the conventional methods.

The image 4 capable of emitting fluorescence upon exposure to ultraviolet light may be formed of a conventional fluorescent material. Examples of highly fluorescent materials usable herein include zinc sulfide, calcium halophosphate, strontium chlorophosphate, aluminates, yttrates, germanates, vanadates, silicates, and tungstates. These fluorescent materials emit light upon exposure to ultraviolet light at a wavelength around 254 nm, and the emission efficiency increases with increasing the particle diameter of the fluorescent materials. In the present invention, however, the particle diameter is preferably about 1 to 10 μm, more preferably 1 to 5 μm, from the viewpoint of transferability at the time of transfer. These fluorescent materials include those capable of emitting bluish white light, those capable of emitting white light, those capable of emitting orange light, those capable of emitting blue light, those capable of emitting green light, those capable of emitting red light and the like. Among them, materials which are proper in a relationship with the sublimable dye image formed on the image-receiving sheet may be selected and used. The fluorescent material layer may be formed of the above fluorescent material and the resin binder.

The protective layer 5 may be formed of various thermally transferable materials. Materials usable in the present invention include resin materials, for example, polyesters (preferably polyethylene terephthalate and polyethylene naphthalate), polycarbonates, polyamides, polyimides, cellulose acetate, polyvinylidene chloride, polyvinyl chloride, polystyrene, fluororesins, polyethylene, polypropylene, cellophanes, and ionomers. In order to enhance the visibility of the image 3 viewable upon exposure to visible light and to improve the reproduction of the hue of the image 3, the protective layer 5 is preferably highly transparent and substantially colorless. The protective layer 5 may have any thickness. Preferably, however, the thickness of the protective layer 5 is about 0.3 to 5.0 μm, particularly preferably 0.5 to 2.5 μm. When the thickness of the protective layer 5 is less than 0.3 μm, the function as the protective layer is unsatisfactory. In this case, disadvantageously, the colorant constituting the image 3 viewable upon exposure to visible light is sometimes reacted with the fluorescent color emitting agent constituting the image 4 capable of emitting fluorescence upon exposure to ultraviolet light.

Further, by virtue of the interposition of the protective layer 5 between the image 3 viewable upon exposure to visible light and the image 4 capable of emitting fluorescence upon exposure to ultraviolet light, the image 3 viewable upon exposure to visible light and the image 4 capable of emitting fluorescence upon exposure to ultraviolet light can be three-dimensionally disposed while providing a space by the thickness of the protective layer 5 between both the images. Therefore, when the image-formed object according to the present invention is placed under an environment in which visible light and ultraviolet light are present together, an image, in which both the image 3 viewable upon exposure to visible light and the image 4 capable of emitting fluorescence upon exposure to ultraviolet light are disposed three-dimensionally, can be viewed.

<Method For Image Formation and Thermal Transfer Sheet For Preparation of Image-formed Object>

The image-formed object 1 according to the present invention can be prepared by a method for image formation in which an image 3 viewable upon exposure to visible light, a protective 5, and an image 4 capable of emitting fluorescence upon exposure to ultraviolet light are formed in that order on an image-receiving sheet 2.

FIG. 2 is a typical cross-sectional view of a preferred embodiment of a thermal transfer sheet for the preparation of an image-formed object, suitable for use in the method for image formation according to the present invention.

In a thermal transfer sheet 6 for use in the preparation of an image-formed object according to the present invention shown in FIG. 2, a colorant transfer layer 8 for forming an image viewable upon exposure to visible. light, a protective layer transfer layer 9 for forming a protective layer, and a fluorescent color emitting agent transfer layer 10 for forming an image capable of emitting fluorescence upon exposure to ultraviolet light are provided on a substrate sheet 7 in a face serial manner.

A release layer 11 is provided to facilitate the separation of the protective layer transfer layer 9 and the fluorescent color emitting agent transfer layer 10. A backside layer 12 is provided to protect the substrate sheet 7 against heat at the time of thermal transfer and to improve slipperiness of the thermal transfer sheet.

The thermal transfer sheet 6 for the preparation of an image-formed object shown in FIG. 2 is put on top of an image-receiving sheet (not shown), followed by thermal transfer. In this case, the colorant transfer layer 8 (preferably, for example, a sublimable yellow dye (8Y), a sublimable magenta dye (8M), and a sublimable cyan dye (8C)) is first transferred onto the image-receiving sheet. Next, the protective layer transfer layer 9 is transferred, and the fluorescent color emitting agent transfer layer 10 is then transferred. The thermal transfer sheet 6 for the preparation of an image-formed object shown in FIG. 2 is advantageous in that, since the release layer 11 improves the separability of the protective layer transfer layer 9 and the separability of the fluorescent color emitting agent transfer layer 10, the thermal transferability is very good.

The release layer 11 should stay on the substrate sheet 7 side upon thermal transfer and should neither adhere nor stay on the transferred protective layer side or the transferred fluorescent color emitting agent side. Accordingly, the release layer may be formed of at least one of, a copolymer of two or more of, or a mixture of two or more of, for example, waxes, silicone waxes, silicone resins, fluororesins, acrylic resins, polyvinyl alcohol resins, cellulose derivative resins, urethane resins, vinyl acetate resins, acryl vinyl ether resins, and maleic anhydride resins. The thickness of the release layer preferably 0.2 to 1.5 μm, particularly preferably 0.3 to 1 μm.

The backside layer 12 contributes to prevent fusing of a thermal head, a heating roll or the like at the time of thermal transfer, to improve the slipperiness, or to impart antistatic properties. The backside layer 12 may be formed of, for example, a material, which has hitherto been commonly used in the field of thermal transfer films. Preferred materials usable herein include, for example, silicone resins, polyvinyl butyral resins, polyvinyl acetoacetal resins, polyester resins, polyether resins, polybutadiene resins, styrene-butadiene copolymers, acrylic polyols, polyurethane acrylates, polyester acrylates, polyether acrylates, epoxy acrylates, prepolymers of urethane or epoxy, nitrocellulose resins, cellulose nitrate resins, cellulose acetopropionate resins, cellulose acetate butyrate resins, cellulose acetate hydrodiene phthalate resins, cellulose acetate resins, aromatic polyamide resins, polyimide resins, polyamide-imide resins, polycarbonate resins, and chlorinated polyolefin resins.

Further, from the viewpoint of improving the heat resistance or coating strength of the backside layer and the adhesion of the backside layer to the substrate sheet, it is possible to use a cured product provided by a reaction of a thermoplastic resin having, in it, a reactive group with a polyisocyanate, or a product of a reaction of the resin with a monomer or oligomer having an unsaturated bond. The curing may be carried out by any means without particular limitation, for example, by heating or by ionizing radiation irradiation.

Slipperiness-imparting agents, which may be added to or coated onto the backside layer of these resins, include phosphoric esters, silicone oils, graphite powder, silicone graft polymers, fluoro graft polymers, acrylsilicone graft polymers, acrylsiloxanes, arylsiloxanes, and other silicone polymers. Preferred is a layer formed of a polyol, for example, a high-molecular polyalcohol compound, a polyisocyanate compound and a phosphoric ester compound. Further, the addition of a filler is more preferred. The thickness of the backside layer 12 is preferably 0.1 to 3 μm, particularly preferably 0.1 to 2 μm.

A substrate sheet employed in the prior art with this type of thermal transfer sheet may be used, as the substrate sheet in the protective layer thermal transfer sheet according to the present invention, either as such or after desired modification. In the present invention, the substrate sheet is preferably formed of a resin material or a paper. Examples of resin materials and papers usable herein include (i) polyesters (preferably polyethylene terephthalate and polyethylene naphthalate), polycarbonates, polyamides, polyimides, cellulose acetate, polyvinylidene chloride, polyvinyl chloride, polystyrene, fluororesins, polypropylene, polyethylene, and ionomers, and (ii) papers such as glassine paper, capacitor paper, and paraffin paper. They may also be used in a combination of two or more. In the present invention, preferred are materials having excellent heat resistance and strength, particularly polyethylene terephthalate and polyethylene naphthalate.

### EXAMPLES

The following Examples and Comparative Examples further illustrate the present invention.

### Example 1

In this Example, a thermal transfer sheet for the preparation of an image-formed object according to the present invention shown in FIG. 2 was prepared by using the following materials and method and was used to prepare an image-formed object according to the present invention shown in FIG. 1. This image-formed object was evaluated according to the following evaluation method.

1. Backside layer (ink for heat-resistant slip layer)

| | |
|---|---|
| Polyvinyl butyral resin | 3.6 pts.wt. |
| Polyisocyanate | 8.6 pts.wt. |
| Phosphoric ester surfactant | 2.8 pts.wt. |
| Talc | 0.7 pt.wt. |
| Methyl ethyl ketone | 32.0 pts.wt. |
| Toluene | 32.0 pts.wt. |

A polyethylene phthalate (PET) sheet was provided as a substrate sheet. The ink for a heat-resistant slip layer was gravure coated at a coverage of 1.0 g/m² on a dry basis, and the coating was dried to form a heat-resistant slip layer as a backside layer on the substrate sheet.

2. Sublimable Dyes

Compositions for sublimable dye region formation were prepared according to the following formulation. These compositions were gravure coated each at a coverage of 0.8 g/m² on a dry basis on the surface of the substrate sheet remote from the backside layer in the order of the yellow composition (8Y), the magenta composition (8M), and the cyan composition (8C). Thus, a colorant transfer layer (a sublimable dye region) shown in FIG. 2 was formed.

Yellow composition (8Y)

| | |
|---|---|
| Quinophthalone dye | 6.0 pts.wt. |
| Polyvinyl acetoacetal resin | 3.0 pts.wt. |
| (KS-5, manufactured by SEKISUI | |
| CHEMICAL CO., LTD.) | |
| Toluene | 45.0 pts.wt. |
| Methyl ethyl ketone | 45.0 pts.wt. |

Magenta composition (8M)

| | |
|---|---|
| Pyrazolotriazole azomethine dye | 4.4 pts.wt. |
| Anthraquinone dye | 1.0 pt.wt. |
| Polyvinyl acetoacetal resin | 3.0 pts.wt. |
| (KS-5, manufactured by SEKISUI | |
| CHEMICAL CO., LTD.) | |
| Toluene | 45.0 pts.wt. |
| Methyl ethyl ketone | 45.0 pts.wt. |

Cyan composition (8C)

| | |
|---|---|
| Indoaniline dye | 4.0 pts.wt. |
| Anthraquinone dye | 1.0 pt.wt. |
| Polyvinyl acetoacetal resin | 3.0 pts.wt. |
| (KS-5, manufactured by SEKISUI | |
| CHEMICAL CO., LTD.) | |
| Toluene | 45.0 pts.wt. |
| Methyl ethyl ketone | 45.0 pts.wt. |

3. Protective Layer Part

Release Layer

A composition for a release layer was prepared according to the following formulation. This composition was gravure coated at a coverage of 0.5 g/m² on a dry basis onto the surface of the substrate sheet to form a release layer.

| | |
|---|---|
| Polyvinyl alcohol resin | 3.0 pts.wt. |
| Urethane resin | 2.0 pts.wt. |
| Isopropyl alcohol | 60.0 pts.wt. |
| Ion-exchanged water | 30.0 pts.wt. |
| Brightening agent (Uvitex CF, | 0.1 pt.wt. |
| manufactured by Ciba Specialty | |
| Chemicals, K.K.) | |

Protective Layer

A composition for a protective layer was prepared according to the following formulation. This composition was gravure coated at a coverage of 0.8 g/m² on a dry basis onto the surface of the release layer to form a protective layer.

| | |
|---|---|
| Vinly chloride-vinyl acetate | 30.0 pts.wt. |
| copolymer resin (VY-LFX, | |
| manufactured by Union Carbide) | |
| Toluene | 35.0 pts.wt. |
| Methyl ethyl ketone | 35.0 pts.wt. |

4. Coating Liquid For Fluorescent Color Emitting Transfer Layer

Release Layer

A composition for a release layer was prepared according to the following formulation. This composition was gravure coated at a coverage of 0.5 g/m² on a dry basis onto the surface of the substrate sheet to form a release layer.

| | |
|---|---|
| Polyvinyl alcohol resin | 3.0 pts.wt. |
| Urethane resin | 2.0 pts.wt. |
| Isopropyl alcohol | 60.0 pts.wt. |
| Ion-exchanged water | 30.0 pts.wt. |
| Brightening agent (Uvitex CF, | 0.1 pt.wt. |
| manufactured by Ciba Specialty | |
| Chemicals, K.K.) | |

Fluorescent color Emitting Transfer Layer

A composition for a fluorescent color emitting transfer layer was prepared according to the following formulation. This composition was gravure coated at a coverage of 0.8 g/m² on a dry basis onto the surface of the release layer to form a fluorescent color emitting transfer layer.

| | |
|---|---|
| Vinly chloride-vinyl acetate | 30.0 pts.wt. |
| copolymer resin (VY-LFX, | |
| manufactured by Union Carbide) | |
| Uvitex OB (manufactured by Ciba | 1.5 pts.wt. |
| Specialty Chemicals, K.K.) | |
| Toluene | 35.0 pts.wt. |
| Methyl ethyl ketone | 35.0 pts.wt. |

### Comparative Example 1

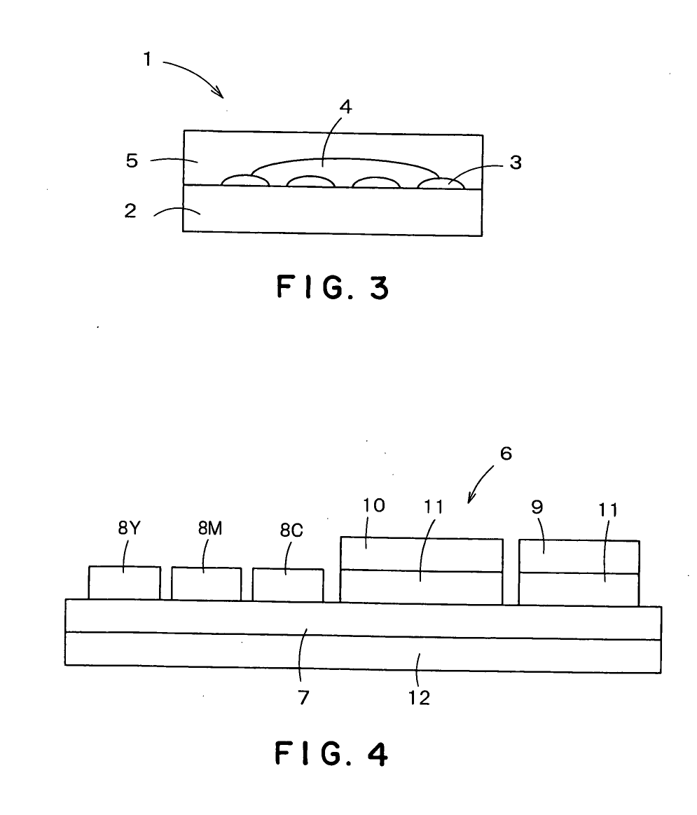

In this Comparative Example, a thermal transfer sheet for the preparation of an image-formed object shown in FIG. 4 was prepared by using the same materials and method as used in Example 1 and was used to prepare an image-formed object shown in FIG. 3. This image-formed object shown in FIG. 3 was evaluated according to the same evaluation methods as used in Example 1.

<<Evaluation 1 (Evaluation and Results)>>

Prints were prepared using samples prepared in Example 1 and Comparative Example 1 under the following conditions and were used for evaluation which will be described later. In all the following evaluation tests, L Size Paper A4 for a digital color printer P-400 manufactured by Olympus Optical Co., LTD. was used as a thermal transfer image-receiving sheet.

1) The thermal transfer sheet described in Example 1 was put on top of the thermal transfer image-receiving sheet to prepare an assembly. Signals obtained by analyzing image 1, which has a reflection density of 0.5 to 0.7 as measured with Macbeth densitometer RD-918 Visual Filter, were conveyed to a thermal head, provided in the above apparatus, by which thermal transfer was carried out using the Y, M, and C sublimable dye transfer layers to form image 1. The protective layer was then thermally transferred by the thermal head provided in the apparatus onto the whole area of the image 1 region in such a manner that the area of the protective layer was larger than the image 1 region. Thereafter, the fluorescent color emitting transfer layer was thermally transferred onto the protective layer transferred region by the thermal head provided in the apparatus to print image 2. Thus, image-formed object 1 was prepared. Image 2 formed of the colorless fluorescent agent was substantially colorless under visible light and could not be viewed without difficulties. On the other hand, upon exposure to commercially available black light (oscillation wavelength: 365 nm), the image-formed part emitted substantially white light and could be clearly viewed.

2) The thermal transfer sheet described in Comparative Example 1 was put on top of the thermal transfer image-receiving sheet to prepare an assembly. Signals obtained by analyzing image 1, which has a reflection density of 0.5 to 0.7 as measured with Macbeth densitometer RD-918 Visual Filter, were conveyed to a thermal head, provided in the above apparatus, by which thermal transfer was carried out using the Y, M, and C sublimable dye transfer layers to form image 1. Fluorescent color emitting image 2 was then formed by thermal transfer by means of the thermal head provided in the apparatus so that fluorescent color emitting image 2 was within the image 1 region. Thereafter, the protective layer transfer layer was thermally transferred by the thermal head provided in the apparatus to print a protective layer so as to cover the fluorescent color emitting image region in such a manner that the area of the protective layer was larger than the image 1 region. Thus, image-formed object 2 was prepared. Image 2 formed of the colorless fluorescent agent was substantially colorless under visible light and could not be viewed without difficulties. On the other hand, upon exposure to commercially available black light (oscillation wavelength: 365 nm), the image-formed part emitted substantially white light and could be clearly viewed.

Lightfastness Test

A lightfastness test was carried out for image-formed object 1 and image-formed object 2.

Fadeometer: Ci 400, manufactured by ATLAS

Light source: xenon arc lamp

Filter: inner side CIRA, outer side soda lime

Black panel temperature: 45° C.

Temperature and humidity within chamber: 30° C., 30% RH

Irradiation energy: 400 kj/m² (integrated irradiation energy at 420 nm)

The sublimable dye density in the fluorescent color emitting image transferred part was measured before and after the lightfastness test to determine a difference in the sublimable dye density between before the lightfastness test and after the lightfastness test.

TABLE 1

| Sample | Before test | After test | Retention |
|---|---|---|---|
| Example 1 | 0.64 | 0.45 | 70% |
| Comparative | 0.64 | 0.37 | 58% |
| Example 1 | | | |

The above results show that, in Example 1, an improvement in lightfastness could be achieved over Comparative Example 1.

### Example 2

A thermal transfer sheet was prepared in the same manner as in Example 1, except that the fluorescent color emitting transfer layer was formed using 2 parts by weight of a phosphate phosphor (Sr₂P₂O₇:Sn²⁺) instead of Uvitex OB as the fluorescent color emitting material.

### Comparative Example 2

A thermal transfer sheet was prepared in the same manner as in Comparative Example 1, except that the fluorescent color emitting transfer layer was formed using 2 parts by weight of a phosphate phosphor (Sr₂P₂O₇:Sn²⁺) as used in Example 2 instead of Uvitex OB as the fluorescent color emitting material.

<<Evaluation 2>>

In the same manner as in Example 1, print samples were prepared using the thermal transfer sheets prepared in Example 2 and Comparative Example 2 according to the method described in Example 1 and were tested for lightfastness.

The sublimable dye density in the fluorescent color emitting image transferred part was measured before and after the lightfastness test to determine a difference in the sublimable dye density between before the lightfastness test and after the lightfastness test.

TABLE 2

| Sample | Before test | After test | Retention |
|---|---|---|---|
| Example 2 | 0.66 | 0.46 | 70% |
| Comparative | 0.66 | 0.34 | 52% |
| Example 2 | | | |

### Example 3

A thermal transfer sheet was prepared in the same manner as in Example 1, except that the fluorescent color emitting transfer layer was formed using 2 parts by weight of Y₂O₃:Eu³⁺ instead of Uvitex OB as the fluorescent color emitting material.

### Comparative Example 3

A thermal transfer sheet was prepared in the same manner as in Comparative Example 1, except that the fluorescent color emitting transfer layer was formed using 2 parts by weight of Y₂O₃:Eu³⁺ used in Example 3 instead of Uvitex OB as the fluorescent color emitting material.

<<Evaluation 3>>

In the same manner as in Example 1, print samples were prepared using the thermal transfer sheets prepared in Example 3 and Comparative Example 3 according to the method described in Example 1 and were tested for lightfastness.

The sublimable dye density in the fluorescent color emitting image transferred part was measured before and after the lightfastness test to determine a difference in the sublimable dye density between before the lightfastness test and after the lightfastness test.

TABLE 3

| Sample | Before test | After test | Retention |
|---|---|---|---|
| Example 3 | 0.60 | 0.43 | 71% |
| Comparative | 0.60 | 0.29 | 51% |
| Example 3 | | | |

In the image-formed object according to the present invention, an image viewable upon exposure to visible light is provided on an image-receiving sheet, and an image capable of emitting fluorescence upon exposure to ultraviolet light is provided on the image viewable upon exposure to the visible light through a protective layer. According to this construction, a photoreaction between the fluorescent color emitting material and the colorant can be prevented to prevent image color fading and the formation of an unsharp image.

1. An image-formed object comprising: an image-receiving sheet; an image, viewable upon exposure to visible light, provided on the image-receiving sheet; and an image, capable of emitting fluorescence upon exposure to ultraviolet light, provided on the image viewable upon exposure to the visible light through a protective layer.

2. The image-formed object according to claim 1, wherein the image capable of emitting fluorescence upon exposure to ultraviolet light is not substantially viewable upon exposure to visible light.

3. The image-formed object according to claim 1, wherein the image capable of emitting fluorescence upon exposure to ultraviolet light has been formed by thermal transfer.

4. The image-formed object according to claim 1, wherein the image viewable upon exposure to visible light has been formed by thermal transfer.

5. A method for image formation, comprising the step of forming an image viewable upon exposure to visible light, a protective layer, and an image capable of emitting fluorescence upon exposure to ultraviolet light in a serial manner on an image-receiving sheet.

6. A thermal transfer sheet for use in the preparation of the image-formed object according to claim 1, said. thermal transfer sheet comprising:
a substrate sheet; and, provided on the substrate sheet,
a colorant transfer layer for forming an image viewable upon exposure to visible light, a protective layer transfer layer for forming a protective layer, and a fluorescent color emitting agent transfer layer for forming an image capable of emitting fluorescence upon exposure to ultraviolet light.

7. A thermal transfer sheet for use in the preparation of the image-formed object according to claim 1, said thermal transfer sheet comprising:
a substrate sheet; and, provided on the substrate sheet in a face serial manner,
a colorant transfer layer for forming an image viewable upon exposure to visible light, a protective layer transfer layer for forming a protective layer, and a fluorescent color emitting agent transfer layer for forming an image capable of emitting fluorescence upon exposure to ultraviolet light.
